(19) United States
(12) Patent Application Publication
(10) Pub. No.: US 2014/0002635 A1
(43) Pub. Date: Jan. 2, 2014

(54) EXTERNAL SURFACE MEASURING APPARATUS AND OPERATION MEATHOD USING SAME

(71) Applicants: HONG FU JIN PRECISION INDUSTRY (ShenZhen) CO., LTD., (US); HON HAI PRECISION INDUSTRY CO., LTD., New Taipei (TW)

(72) Inventors: TENG-TSUNG HUANG, New Taipei (TW); GUO-JUN YU, Shenzhen (CN); YONG-BING HU, Shenzhen (CN); GONG-SHUI CHENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,581

(22) Filed: Dec. 25, 2012

(30) Foreign Application Priority Data
Jun. 29, 2012 (CN) 2012102207360

(51) Int. Cl. G01B 11/14

(52) U.S. Cl. CPC G01B 11/14
USPC 348/135

(57) ABSTRACT

A external surface measuring apparatus includes a moving element, a securing element, and a measuring element. The securing element is mounted on the moving element, and includes a cylinder and a holding portion mounted on the cylinder, the holding portion holds a workpiece which has several buttons protruding from different external surfaces. The measuring element includes a plurality of measuring devices spaced on the moving element. The moving element drives the workpiece to pass in front of the measuring devices in a certain order, the measuring devices measure the height difference between the buttons and the external surfaces and the gap between sidewalls of the buttons and the external surfaces of the workpiece. The cylinder rotates the workpiece to different buttons for measurement.

### BACKGROUND

1. Technical Field

The present disclosure relates to external surface measuring apparatuses, and particularly to a external surface measuring apparatus measuring physical characteristics.

2. Description of Related Art

A plurality of buttons can be found mounted on an external surface of an electronic device. When manufacturing the electronic device, the height difference between the buttons and the external surface and the gap between sidewalls of the buttons and the external surface need to be measured. However, different steps are required to carry out the abovementioned measuring, which reduces efficiency.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a measuring apparatus applied to the exterior of an electronic device mounted in a cabinet.

FIG. 2 is an assembled, isometric view of an exemplary embodiment of the external surface measuring apparatus.

FIG. 3 is an exploded, isometric view of the external surface measuring apparatus shown in FIG. 2.

FIG. 4 is an assembled, isometric view of an exemplary embodiment of the external surface measuring apparatus shown in FIG. 2 when measuring an electronic device.

FIG. 5 is an assembled, isometric view of an exemplary embodiment of the external surface measuring apparatus shown in FIG. 2 when measuring an electronic device in another state.

FIG. 6 is a flow chart of an operation method of the external surface measuring apparatus shown in FIG. 2.

FIG. 7 shows sub-steps of one step of the operation method of FIG. 6.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

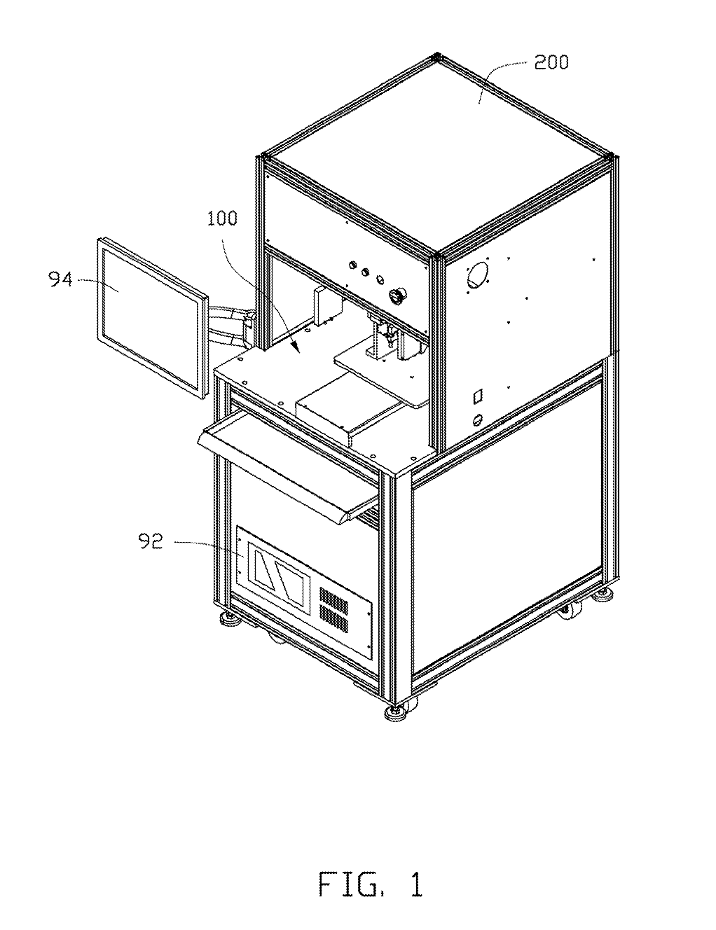

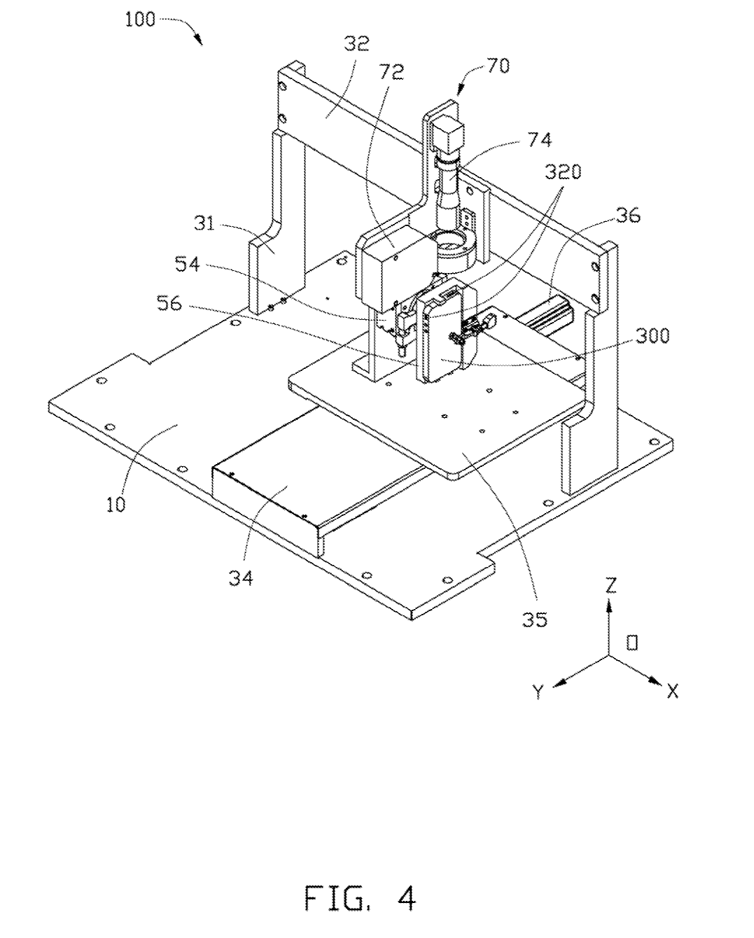

FIG. 1 is an assembled, isometric view of an exemplary embodiment of an external surface measuring apparatus 100 mounted in a cabinet 200. Also referring to FIG. 4, the external surface measuring apparatus 100 is used to measure a workpiece such as an electronic device 300. The electronic device 300 includes several buttons 320 mounted on different external surfaces. The external surface measuring apparatus 100 measures physical characteristics e.g. the height difference between the buttons and the external surface and the gap between sidewalls of the buttons and the external surface.

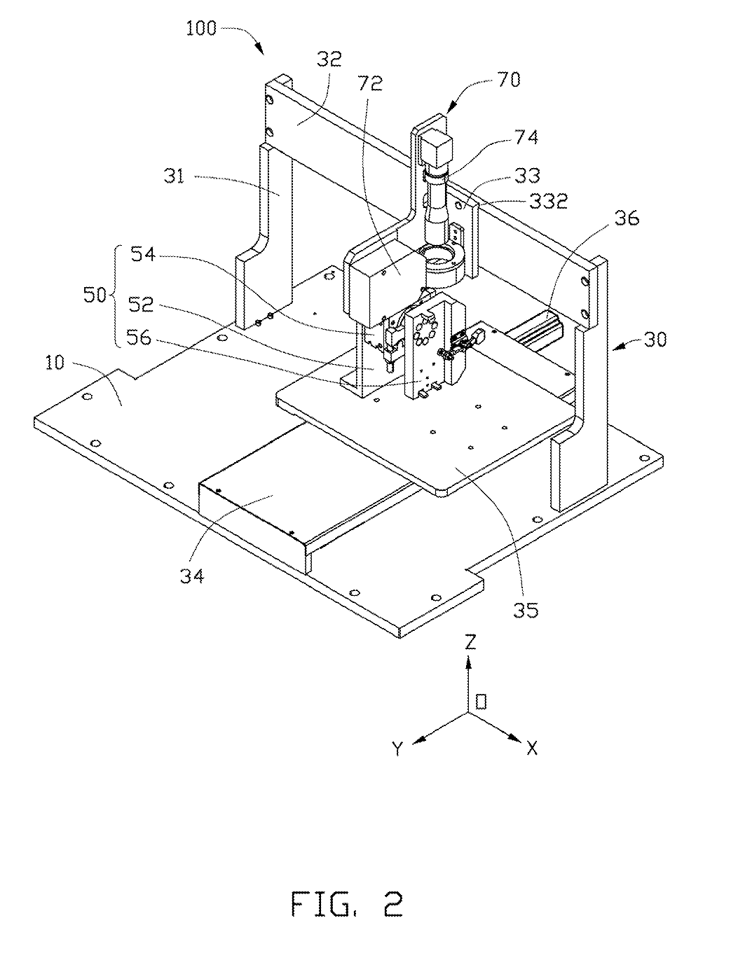

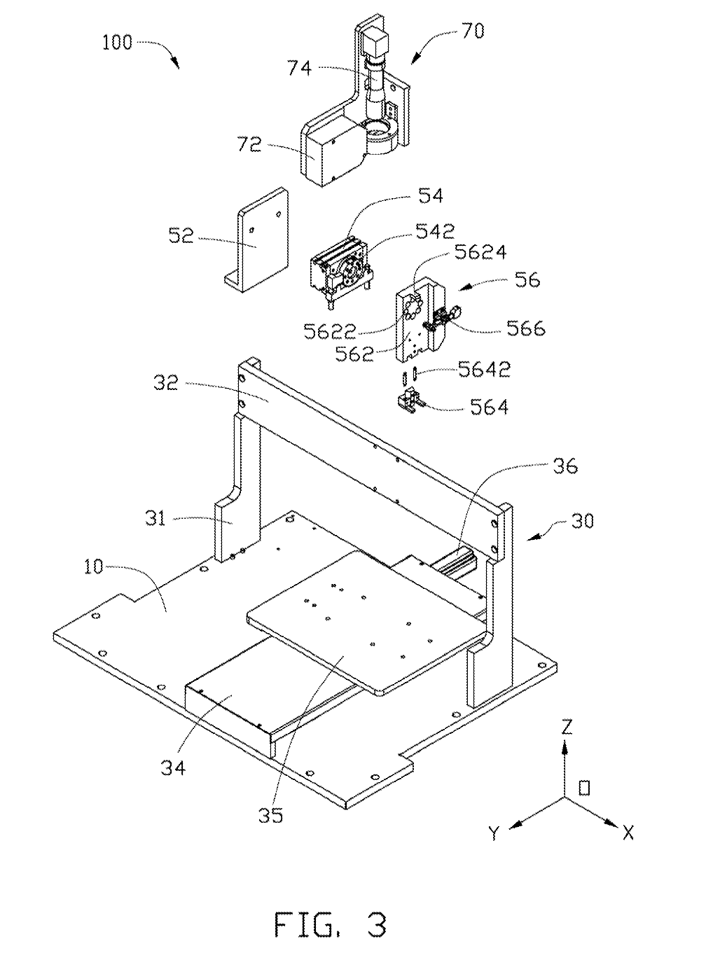

FIG. 2 is an assembled, isometric view of an exemplary embodiment of the external surface measuring apparatus 100. FIG. 3 is an exploded, isometric view of the external surface measuring apparatus 100 shown in FIG. 2. The external surface measuring apparatus 100 includes a base board 10, a moving element 30, a securing element 50, and a measuring element 70. The moving element 30 is mounted on the base board 10. The securing element 50 and the measuring element 70 are mounted on the moving element 30, the moving element 30 drives the securing element 50 and the measuring element 70.

The moving element 30 includes two columns 31, a crossbeam 32, a connecting board 33, a guiding board 34, a moving platform 35, and a motor 36. The two columns 31 are distanced and mounted vertically on the base board 10, the crossbeam 32 is mounted horizontally between the two columns 31. The connecting board 33 is slidably mounted on the crossbeam 32. In the present embodiment, the connecting board 33 includes a group of sliding rails 332 at opposite ends, which are engaged with the edges of the crossbeam 32 so that the connecting board 33 can slide along the X-axis direction of the base board 10. The guiding board 34 is mounted along the Y-axis direction on the base board 10. The moving platform 35 is slidably mounted on the guiding board 34, the moving platform 35 is located furthest from the columns 31 in a initial state. The motor 36 is attached to one end of the guiding board 34 and near to the columns 31. The motor 36 drives the moving platform 35 along the Y-axis direction between the columns 31.

The securing element 50 is attached to the moving platform 35, which secures the workpiece to be measured. The securing element 50 includes a stand board 52, a cylinder 54, and a holding portion 56. The stand board 52 is mounted vertically on the moving platform 35. The cylinder 54 is mounted on an upper end of the stand board 52. In the present embodiment, the cylinder 54 is a rotating cylinder, including a rotating portion 542 trailing the stand board 52. The holding portion 56 is mounted on the cylinder 54, which holds the workpiece. The holding portion 56 includes a supporting board 562, a stopper portion 564, and a retaining portion 566. The supporting board 562 supports a workpiece. One end of the supporting board 562 provides a connecting portion 5622 and a block 5624, the connecting portion 5622 is connected to the rotating portion 542, so that the supporting board 562 can be driven by the cylinder 54. The stopper portion 564 is movably mounted on the opposite end of the supporting board 562 by two elastic pieces 5642, and the stopper portion 564 can move forward or backward from the supporting board 562. The retaining portion 566 is arranged on a central portion of the supporting board 562, which retains the workpiece on the supporting board 562. In the present embodiment, the retaining portion 566 is a lever. One end of the retaining portion 566 extends onto the supporting board 562, and the other end of the retaining portion 566 extends outside the supporting board 562, the supporting board 562 controls the retaining portion 566 to clamp or release the workpiece.

FIG. 4 is an assembled, isometric view of an exemplary embodiment of the external surface measuring apparatus 100 shown in FIG. 2 when measuring the electronic device 300. The electronic device 300 includes several buttons 320 arranged on the different external surfaces. The electronic device 300 is held by the holding portion 56. The measuring element 70 is mounted in the connecting board 33, and measures some dimensions e.g. the height difference between the buttons 320 and the external surface and the gap between sidewalls of the buttons 320 and the external surface of the electronic device 300. The measuring element 70 includes a first measuring device and a second measuring device. In the present embodiment, the first measuring device is a laser camera 72, the second measuring device is a Charge-Coupled Device (CCD) camera 74. The laser camera 72 and the CCD camera 74 are mounted so as to be able to move along the Y-axis direction. With the connecting board 33, the laser camera 72 and the CCD camera 74 can be moved together along the X-axis direction. The motor 36 drives the moving platform 35 to move between the columns 31, meanwhile the electronic device 300 was held by the securing element 50 moves together with the moving platform 35, and the electronic device 300 passes in front of the laser camera 72 then the CCD camera 74.

The laser camera 72 and the CCD camera 74 are electrically connected to a computer 92 and a monitor 94 (shown in FIG. 1). The laser camera 72 emits a laser onto the buttons 320 and the surrounding area. The computer 92 calculates the height difference between the buttons 320 and the external surface of the electronic device 300 according to the laser reflection time. Then the monitor 94 displays the measurement. The CCD camera 74 capture images of a profile of the external surface of the electronic device 300. The computer 92 calculates the gap between the sidewalls of the buttons 320 and the external surface, the monitor 94 then displays the measurement. The computer 92 can further compares the measurement against a preset allowable error range, and determines whether the assembly of the buttons 320 meets a parameter or standard, and then displays the result of comparison.

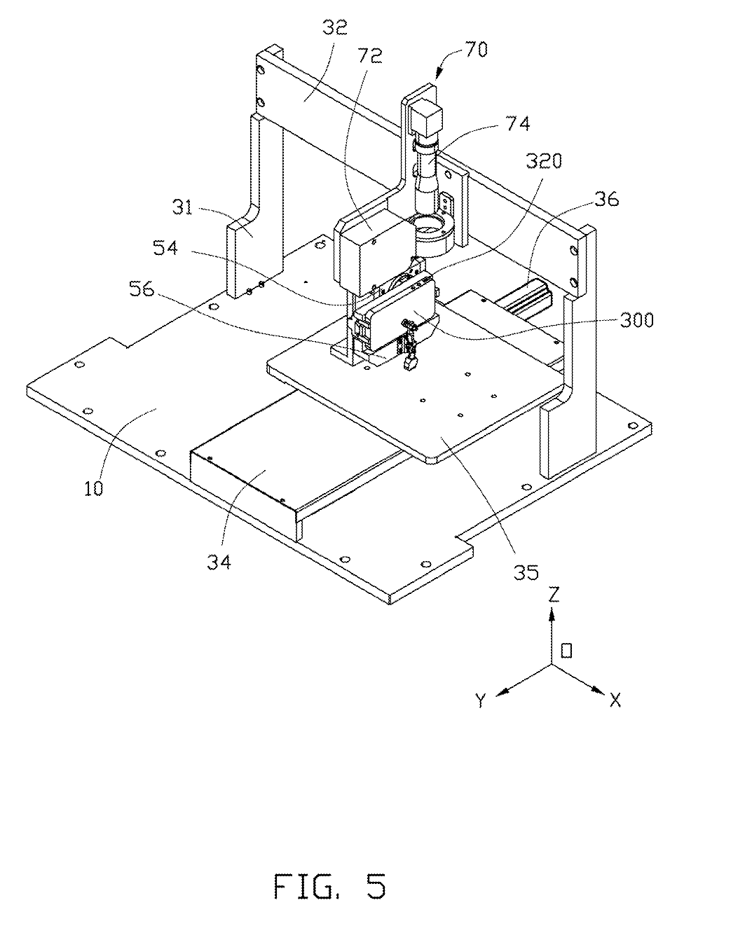

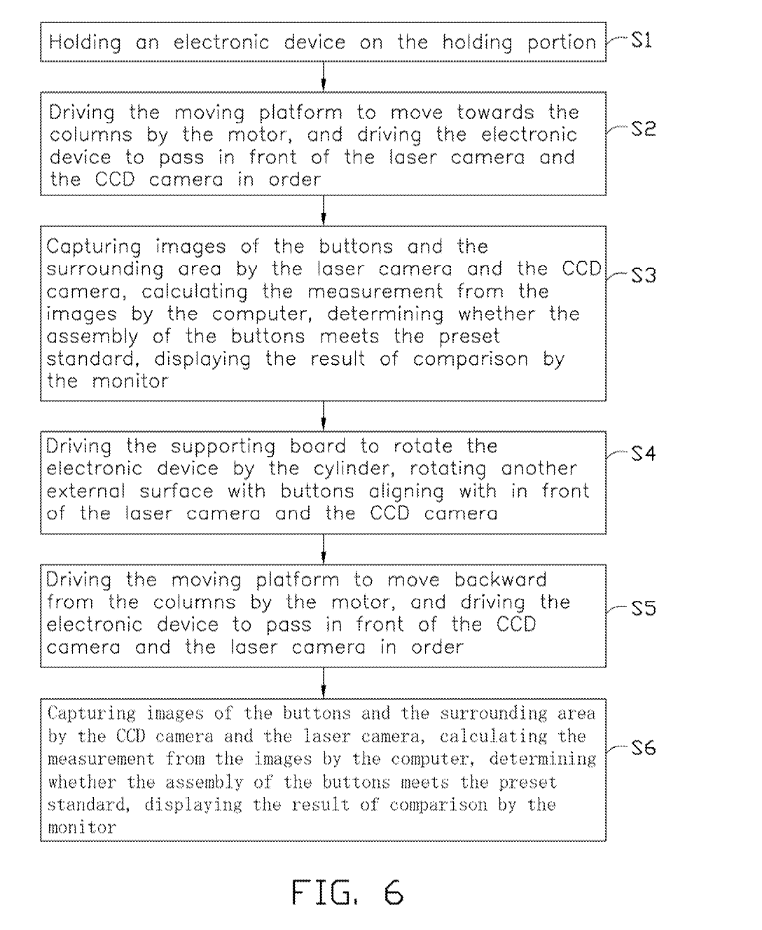

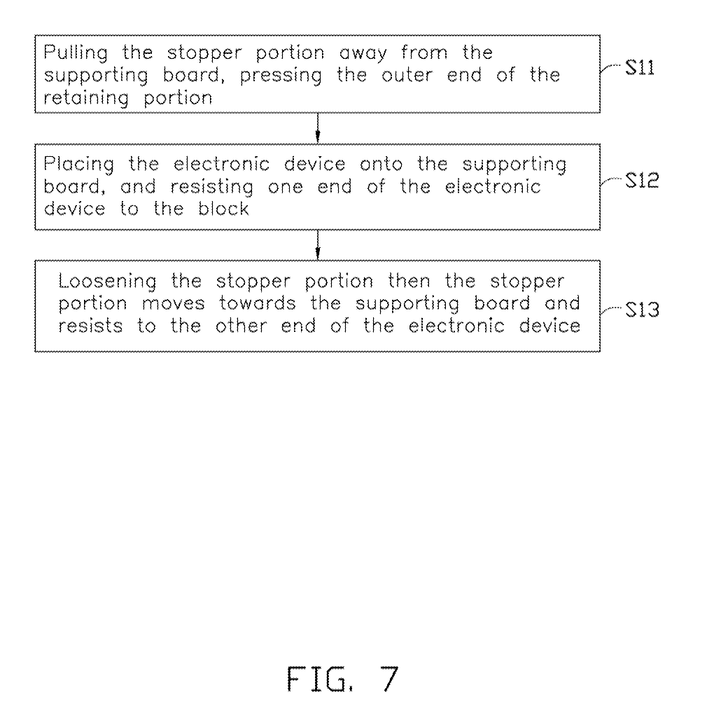

FIG. 5 is an assembled, isometric view of an exemplary embodiment of the external surface measuring apparatus 100 shown in FIG. 2, when measuring an electronic device 300 in another state. In relation to the operation in FIG. 4, the external surface measuring apparatus 100 is measuring another surface of the electronic device 300 in FIG. 5. Referring to FIG. 6 and FIG. 7, an operation method of the external surface measuring apparatus 100 includes the following steps:

Step 1, holding an electronic device 300 in the holding portion 56.

Step 1 further includes the following sub-steps: step 11, pulling the stopper portion 564 away from the supporting board 562, and pressing the outer end of the retaining portion 566. Step 12, placing the electronic device 300 onto the supporting board 562, and abutting one end of the electronic device 300 against the block 5624. Step 13, loosening the stopper portion 564 to allow the stopper portion 564 to move towards the supporting board 562 and abut the other end of the electronic device 300.

Step 2, driving the moving platform 35 to move along the X-axis direction between the columns 31 by the motor 36, and driving the electronic device 300 passing the below of the laser camera 72 and the CCD camera 74 orderly.

Step 3, the laser camera 72 and the CCD camera 74 capture images of the buttons 320 and of the surrounding area, the computer 92 calculates the measurements from the images, and determines whether the assembly of the buttons 320 meets a preset standard, and then the monitor 94 displays the results of comparison.

Step 4, the cylinder 54 drives the supporting board 562 to rotate the electronic device 300, so that another external surface with buttons 320 is presented to the laser camera 72 and the CCD camera 74.

Step 5, the motor 36 drives the moving platform 35 to move backwards, or in the reverse direction, and drives the electronic device 300 to pass in front of the CCD camera 74 and the laser camera 72 in the reverse order.

Step 6, the CCD camera 74 and the laser camera 72 capture images of the buttons 320 and the surrounding area, the computer 92 calculates the measurements from the images, and determines whether the assembly of the buttons 320 meets the preset standard, and then the monitor 94 displays the results of comparison.

The external surface measuring apparatus 100 can, at the same time, take measurements, e.g., of the height difference between the buttons 320 and the external surface and of the gap between sidewalls of the buttons 320 and the external surface of the electronic device 300, and can also take similar measurement of buttons 320 on different external surfaces after rotating the electronic device 300, which is far more efficient. The operation method of the external surface measuring apparatus 100 is automatic and convenient.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A external surface measuring apparatus, comprising:
a moving element;
a securing element, mounted on the moving element, including a cylinder and a holding portion mounted on the cylinder, wherein the holding portion holds a workpiece having several buttons protruding from different external surfaces; and
a measuring element, including a plurality of measuring devices mounted spaced on the moving element; wherein the moving element drives the workpiece to pass in front of the measuring devices in order, the measuring devices measure the height difference between the buttons and the external surface and the gap between sidewalls of the buttons and the external surface of the workpiece; the cylinder rotates the workpiece to measures the buttons on different external surface.

2. The external surface measuring apparatus of claim 1, wherein the securing element includes a supporting board, a stopper portion, and a retaining portion; one end of the supporting board defines a block and a connecting portion; the stopper portion is movably mounted on the opposite end of the supporting board by two elastic pieces; the retaining portion is mounted on the central portion of the supporting board.

3. The external surface measuring apparatus of claim 2, wherein when the stopper portion is moved backward from the supporting board, the workpiece is placed on the supporting board, and one end of the workpiece clamp to the block, the stopper portion moves between the supporting board by elastic power of the two elastic pieces, then the stopper portion clamp to the workpiece, so that the workpiece was held by the block and the stopper portion on the supporting board.

4. The external surface measuring apparatus of claim 3, wherein the retaining portion is a lever, one end extends onto the supporting board, the other end extends outside the supporting board, the end above the supporting board of the retaining portion clamp to the workpiece.

5. The external surface measuring apparatus of claim 3, wherein the cylinder is a rotating cylinder, including a rotating portion, the rotating portion is connected to the connecting portion, so that the cylinder rotates the holding portion to rotate the workpiece held by the holding portion.

6. The external surface measuring apparatus of claim 1, further comprising a base board, wherein the moving element includes two columns, a crossbeam, a connecting board, a guiding board, a moving platform, and a motor; the two columns are distanced and mounted vertically on the base board, the crossbeam is mounted horizontally between the two columns, the connecting board is slidably mounted on the crossbeam, the guiding board is mounted on the base board, the moving platform is slidably mounted on the guiding board, which can move relative to the columns.

7. The external surface measuring apparatus of claim 6, wherein the connecting board includes a group of sliding rails at opposite ends, which are engaged with the edges of the crossbeam.

8. The external surface measuring apparatus of claim 6, wherein the securing element further includes a stand board, which is mounted on the moving platform, the cylinder is mounted on the stand board.

9. The external surface measuring apparatus of claim 6, wherein the plurality of measuring devices includes a laser camera and a Charge-Coupled Device (CCD) camera, the laser camera and the CCD camera are mounted neighboring in the connecting board, and are movable together with the connecting board.

10. The external surface measuring apparatus of claim 9, wherein the plurality of measuring devices are electrically connected to a computer and a monitor, the measuring devices capture images of the buttons and the surrounding area of the workpiece and transmit to the computer, the computer calculates the height difference between the buttons and the external surface, and the distance between sidewalls of the buttons and the external surface of the workpiece, the monitor displays the measurement.

11. The external surface measuring apparatus of claim 9, wherein when the workpiece passes in front of the measuring devices, the measuring devices are aimed at the buttons and the surrounding area of the external surface of the workpiece.

12. An operation method of a external surface measuring apparatus, the method comprising the following steps:
holding a workpiece having buttons on a holding portion;
driving a moving platform to move towards columns by a motor, and driving the workpiece to pass in front of a laser camera and a CCD camera in order;
capturing images of the buttons and a surrounding area by the laser camera and the CCD camera, calculating the measurements from the images by a computer, determining whether the assembly of the buttons meet a preset standard, displaying the result of comparison by the monitor;
driving a supporting board to rotate the workpiece by a cylinder, rotating another external surface with buttons aligning with in front of the laser camera and the CCD camera;
driving the moving platform to move backward from the columns by the motor, and driving the workpiece to pass in front of the CCD camera and the laser camera in order;
capturing images of the buttons and the surrounding area by the CCD camera and the laser camera, calculating the measurements from the images by the computer, determining whether the assembly of the buttons meet the preset standard, displaying the result of comparison by the monitor.

13. The operation method of claim 12, wherein the step of holding the workpiece on the holding portion comprising:
pulling a stopper portion away from the supporting board, pressing an outer end of a retaining portion;
placing the workpiece onto the supporting board, and resisting one end of the workpiece to a block;
loosening the stopper portion then the stopper portion moves towards the supporting board and resists to the other end of the workpiece.

14. A cabinet with a external surface measuring apparatus, comprising:
a computer;
a monitor;
a moving element;
a securing element, mounted on the moving element, including a cylinder and a holding portion mounted on the cylinder, wherein the holding portion holds a workpiece having several buttons protruding from different external surfaces; and
a measuring element, electrically connected to the computer and the monitor, including a plurality of measuring devices mounted spaced on the moving element; wherein the moving element drives the workpiece to pass in front of the measuring devices in order, the measuring devices measure the height difference between the buttons and the external surface and the distance between sidewalls of the buttons and the external surface of the workpiece; the cylinder rotates the workpiece to measures the buttons on different external surface thereof, the computer calculates the measurement, and the monitor displays the result.

15. The cabinet of claim 14, wherein the securing element includes a supporting board, a stopper portion, and a retaining portion; one end of the supporting board defines a block and a connecting portion; the stopper portion is movably mounted on the opposite end of the supporting board by two elastic pieces; the retaining portion is mounted on the central portion of the supporting board.

16. The cabinet of claim 15, wherein the stopper portion is moved backward from the supporting board, the workpiece is placed on the supporting board, and one end of the workpiece clamp to the block, the stopper portion moves towards the supporting board by elastic power of the two elastic pieces, then the stopper portion clamp to the workpiece, so that the workpiece is held by the block and the stopper portion on the supporting board.

17. The cabinet of claim 16, wherein the retaining portion is a lever, one end extends onto the supporting board, the other end extends outside the supporting board, the end above the supporting board of the retaining portion clamps to the workpiece.

18. The cabinet of claim 16, wherein the cylinder is a rotating cylinder, including a rotating portion, the rotating portion is connected to the connecting portion, so that the cylinder can rotate the holding portion to rotate the workpiece held by the holding portion.

19. The cabinet of claim 14, further comprising a base board, wherein the moving element includes two columns, a crossbeam, a connecting board, a guiding board, a moving platform, and a motor; the two columns are distanced and mounted vertically on the base board, the crossbeam is mounted horizontally between the two columns, the connecting board is slidably mounted on the crossbeam, the guiding board is mounted on the base board, the moving platform is slidably mounted on the guiding board, which can move relative to the columns.

20. The cabinet of claim 19, wherein the plurality of measuring devices includes a laser camera and a Charge-Coupled Device (CCD) camera, the laser camera and the CCD camera are mounted neighboring in the connecting board, and is movable together with the connecting board.
